(19) United States
(12) Patent Application Publication
(10) Pub. No.: US 2006/0030992 A1
(43) Pub. Date: Feb. 9, 2006

(54) Deceleration control apparatus and deceleration control method for vehicle

(75) Inventors: Kunihiro Iwatsuki, Toyota-shi (JP); Kazuyuki Shiiba, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/179,557

(22) Filed: Jul. 13, 2005

(30) Foreign Application Priority Data
Jul. 26, 2004 (JP) 2004-217867

(51) Int. Cl. G06F 17/00

(52) U.S. Cl. 701/93; 701/70; 701/55

(57) ABSTRACT

With a deceleration control apparatus and method for a vehicle, which performs deceleration control of a vehicle based on at least a road inclination when a driver's intention to decelerate the vehicle is detected, at least one of a deceleration applied to the vehicle and a threshold used in performing the deceleration control is changed based on a change of a road inclination of a to-be-taken road located ahead of a cruising road on which the vehicle is presently running or will run soon with respect to a road inclination of the cruising road, the change corresponding to a downhill inclination with respect to the cruising road.

### CROSS-REFERENCE TO RELATED APPLICATIONS

This application claims the benefit under 35 U.S.C. § 119 of the earliest filing date of Japanese Patent Application No. 2004-217867 filed on Jul. 26, 2004, the entire disclosure of which is incorporated herein by reference.

### BACKGROUND OF THE INVENTION

1. Field of the Invention

The invention relates to a deceleration control apparatus and deceleration control method for a vehicle. More specifically, the invention relates to a deceleration control apparatus and deceleration control method for a vehicle making it possible to cause a deceleration appropriate for a driver based on a change of a road inclination of a to-be-taken road with respect to a road inclination of a cruising road.

2. Description of the Related Art

Japanese Patent Application Publication No. JP(A)-08-28676 discloses a technology for controlling a shift speed based on a road inclination.

It may be difficult or impossible for a driver to visually check a condition of a to-be-taken road in some cases of road inclinations of the to-be-taken road. For example, a degree of ease in checking the condition of the to-be-taken road varies according to a change of the road inclination of the to-be-taken road with respect to a road inclination of a cruising road.

When it is difficult for the driver to check the condition of the to-be-taken road due to the change of the road inclination of the to-be-taken-road with respect to the road inclination of the cruising road, the driver is likely to feel anxious. Accordingly, it is desirable to make it possible to cause sufficient deceleration.

### SUMMARY OF THE INVENTION

In light of the above-mentioned circumstances, embodiments of the invention provide a deceleration control apparatus and deceleration control method for a vehicle making it possible to cause an appropriate deceleration for a driver based on a change of a road inclination of a to-be-taken road with respect to a road inclination of a cruising road.

According to an aspect of the invention, there is provided a deceleration control apparatus for a vehicle, which performs vehicle deceleration control based on at least a road inclination when a driver's intention to decelerate the vehicle is detected. The deceleration control apparatus for the vehicle includes a controller which changes at least one of deceleration applied to the vehicle and a degree of ease in performing the deceleration control based on a change of a road inclination of a to-be-taken road located ahead of a cruising road on which the vehicle is presently running or will run soon with respect to a road inclination of the cruising road, the change corresponding to a downhill inclination with respect to the cruising road.

According to another aspect of the invention, there is provided a deceleration control method for a vehicle in which vehicle deceleration control is performed based on at least a road inclination when a driver's intention to decelerate a vehicle is detected. The deceleration control method for a vehicle includes the steps of: detecting a change of a road inclination of a to-be-taken road located ahead of a cruising road on which the vehicle is presently running or will run soon with respect to a road inclination of the cruising road, the change corresponding to a downhill inclination with respect to the cruising road; and changing at least one of deceleration applied to the vehicle and a degree of ease in performing the deceleration control based on the change corresponding to the downhill inclination with respect to the cruising road.

According to the above-mentioned deceleration control apparatus and deceleration control method for a vehicle, it is possible to cause deceleration appropriate for the driver based on the change of the road inclination of the to-be-taken road with respect to the road inclination of the cruising road.

### BRIEF DESCRIPTION OF THE DRAWINGS

The features, advantages thereof, and technical and industrial significance of embodiments of the present invention will be better understood by reading the following detailed description of preferred embodiments when considered in connection with the accompanying drawings, in which:

FIGS. 1A and 1B illustrate flowcharts showing an operation of a deceleration control apparatus for a vehicle according to a first embodiment of the invention;

FIG. 2 illustrates schematically the deceleration control apparatus for a vehicle according to the first embodiment;

FIG. 3A illustrates a lateral view of an example of a road shape describing a change of a road inclination of a to-be-taken road with respect to a road inclination of a cruising road, the change impairing driver's visibility;

FIG. 3B illustrates a lateral view of another example of a road shape describing a change of a road inclination of a to-be-taken road with respect to a road inclination of a cruising road, the change impairing driver's visibility;

FIG. 3C illustrates a lateral view of another example of a road shape describing a change of a road inclination of a to-be-taken road with respect to a road inclination of a cruising road, the change impairing driver's visibility;

FIG. 3D illustrates a lateral view showing another example of a road shape describing a change of a road inclination of a to-be-taken road with respect to a road inclination of a cruising road, the change impairing driver's visibility;

FIG. 4 illustrates shift speed maps used in the deceleration control apparatus for a vehicle according to the first embodiment;

FIG. 5 illustrates a view describing an effect of the deceleration control apparatus for a vehicle according to the first embodiment;

FIGS. 6A and 6B illustrate flowcharts showing an operation of a deceleration control apparatus for a vehicle according to a second embodiment of the invention;

FIGS. 7A, 7B, and 7C illustrate flowcharts showing an operation of a deceleration control apparatus for a vehicle according to a third embodiment of the invention;

FIGS. 8A, 8B, and 8C illustrate flowcharts showing an operation of a deceleration control apparatus for a vehicle according to a fourth embodiment of the invention;

FIG. 9 illustrates a graph describing a control performing boundary line used in the deceleration control apparatus for a vehicle according to the fourth embodiment;

FIG. 10 illustrates shift speed maps used in the deceleration control apparatus for a vehicle according to the fourth embodiment; and

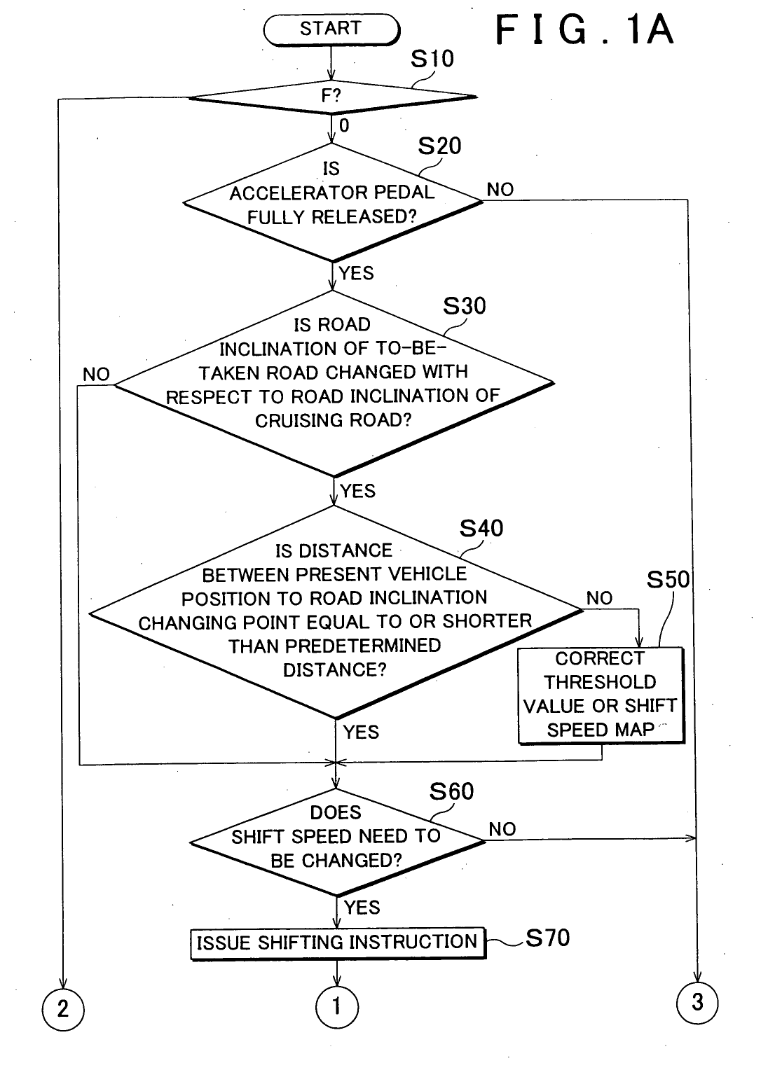

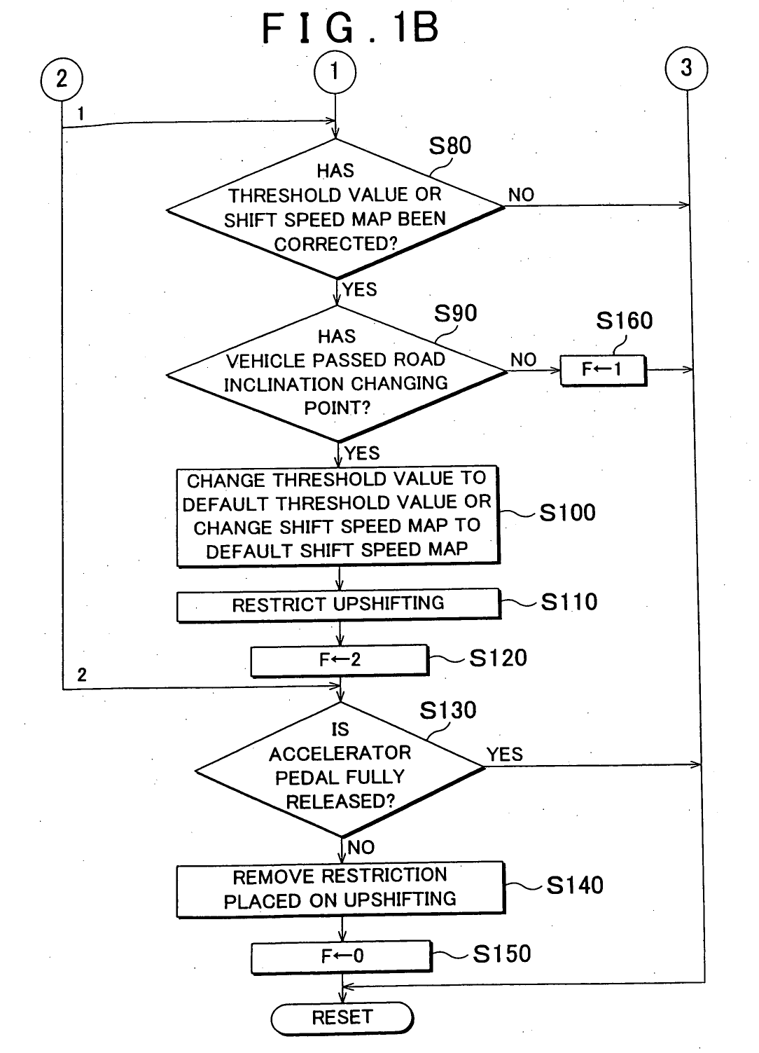

FIG. 1 illustrates a time chart showing an operation of the deceleration control apparatus for a vehicle according to the fourth embodiment.

### DETAILED DESCRIPTION OF EXEMPLARY EMBODIMENTS

In the following description and the accompanying drawings, the invention will be described in more detail with reference to exemplary embodiments. A first embodiment of the invention will be described with reference to FIGS. 1A-1B, 2, 3A-3D, 4, and 5. The first embodiment relates to a deceleration control apparatus for a vehicle, which controls an automatic transmission based on a road inclination.

In the first embodiment, when a driver's intention to decelerate a vehicle is detected, the deceleration control apparatus controls the automatic transmission thereby causing a desired deceleration based on a road inclination. The deceleration control apparatus changes control for the deceleration to be caused (e.g., a threshold value for determining whether the control needs to be performed, an amount of deceleration) based on an amount of a change of a road inclination of a road located ahead of a road on which the vehicle is presently running or will run soon (hereinafter, a road on which the vehicle is presently running or will run soon will be referred to as a “cruising road,” and a road located ahead of the cruising road will be referred to as a “to-be-taken road”) with respect to a road inclination of the cruising road.

When the amount of change of the road inclination of the to-be-taken road with respect to the road inclination of the cruising road, the change corresponding to the downhill inclination with respect to the cruising road, is larger than a predetermined value, a degree of ease in performing the deceleration control is increased and/or deceleration applied to the vehicle is increased. In this case, if a distance between a present vehicle position and a point at which the road inclination of the to-be-taken road changes with respect to the road inclination of the cruising road (hereinafter, referred to as a “road inclination changing point”) is equal to or shorter than a predetermined distance, the control for deceleration (e.g., a threshold value for determining whether the control needs to be performed, an amount of deceleration) is not changed.

In the first embodiment, as described later in detail, there are provided a transmission which can change a shift speed or a speed ratio; a device which detects or estimates a road inclination; and a device which controls the transmission based on the road inclination.

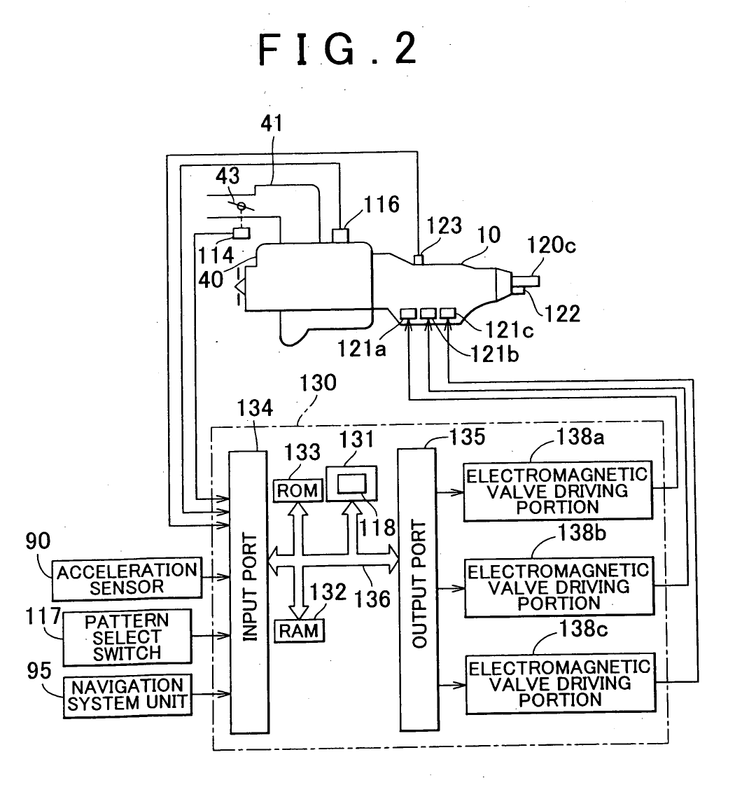

In FIG. 2, reference numeral “10” signifies a stepped automatic transmission, and reference numeral “40” signifies an engine. In the automatic transmission 10, hydraulic pressure is controlled by energizing/de-energizing electromagnetic valves 121a, 121b, and 121c, whereby shifting can be performed. FIG. 2 shows the three electromagnetic valves 121a, 121b, and 121c. However, the number of the electromagnetic valves is not limited to “3.” The electromagnetic valves 121a, 121b, and 121c are driven under control of a signal from a control circuit 130.

A throttle valve opening amount sensor 114 detects an opening amount of a throttle valve 43 provided in an intake passage 41 of the engine 40. An engine rotational speed sensor 116 detects a rotational speed of the engine 40. A vehicle speed sensor 122 detects a rotational speed of an output shaft 120c of the automatic transmission 10, which is proportional to a vehicle speed. A shift position sensor 123 detects a shift position. A pattern select switch 117 is used when an instruction on a shift pattern is given. An acceleration sensor 90 detects deceleration of the vehicle.

A basic function of a navigation system unit 95 is to guide a host vehicle (hereinafter, referred to as a “vehicle”) to a predetermined destination. For example, the navigation system unit 95 can include an arithmetic processing unit; an information storing medium in which information required for running of the vehicle (e.g., maps, straight roads, curves, up-hill/down-hill roads, highways) is stored; a first information detecting device which detects a present vehicle position and a road condition by self navigation, and which includes a geomagnetic sensor, a gyro compass, and a steering sensor; and a second information detecting device which detects the present vehicle position and the road condition by radio navigation, and which includes a GPS antenna, a GPS receiver, and the like.

A road inclination measuring/estimating portion 118 may be provided as a part of a CPU 131. The road inclination measuring/estimating portion 118 measures or estimates a road inclination based on the acceleration detected by the acceleration sensor 90. The road inclination measuring/estimating portion 118 obtains the road inclination by comparing the acceleration on a flat road, which is stored in ROM 133 in advance, with the acceleration actually detected by the acceleration sensor 90.

The control circuit 130 receives signals indicating detection results from the throttle valve opening amount sensor 114, the engine rotational speed sensor 116, the vehicle speed sensor 122, the shift position sensor 123, and the acceleration sensor 90. The control circuit 130 also receives a signal indicating a switching state of the pattern select switch 117 and a signal from the navigation system unit 95.

The control circuit 130 is formed of a known microcomputer, and includes the CPU 131, RAM 132, the ROM 133, an input port 134, an output port 135, and a common bus 136. The input port 134 receives signals from the above-mentioned sensors 114, 116, 122, 123, and 90, a signal from the pattern select switch 117, and a signal from the navigation system unit 95. The output port 135 is connected to electromagnetic valve driving portions 138a, 138b, and 138c.

The ROM 133 stores a program of an operation shown in a flowchart in FIGS. 1A and 1B (control steps) in advance. The ROM 133 also stores a shift speed map based on which a shift speed of the automatic transmission 10 is changed and a program of an operation of the shift control (not shown). The control circuit 130 performs shifting of the automatic transmission 10 under various control conditions input therein.

An operation of the deceleration control apparatus in the first embodiment will be described with reference to FIGS. 1A, 1B, and 2. In step S10, the control circuit 130 checks a flag F. When the flag F shows “0”, step S20 is performed. When the flag F shows “1”, step S80 is performed. When the flag F shows “2”, step S130 is performed. When the control routine is initially performed, the flag F shows “0”. Therefore, step S20 is then performed.

In step S20, the control circuit 130 determines whether an accelerator pedal is fully released based on a signal from the throttle valve opening amount sensor 114. When it is determined in step S20 that the accelerator pedal is fully released, step S30 is performed. When the accelerator pedal is fully released (“YES” in step S20), it is determined that the driver has an intention of decelerating the vehicle, and the deceleration control according to the first embodiment is performed. On the other hand, when it is not determined that the accelerator pedal is fully released (“NO” in step S20), the control routine is reset.

In step S30, the control circuit 130 determines whether there is a change of a road inclination of a to-be-taken road with respect to a road inclination of a cruising road, the change impairing driver's visibility. A state for which there is a change that impairs driver's visibility signifies that the road inclination of the to-be-taken road changes with respect to the road inclination of the cruising road by at least a predetermined value, the change corresponding to a downhill inclination with respect to the cruising road. The predetermined value is stored in the ROM 133 in advance.

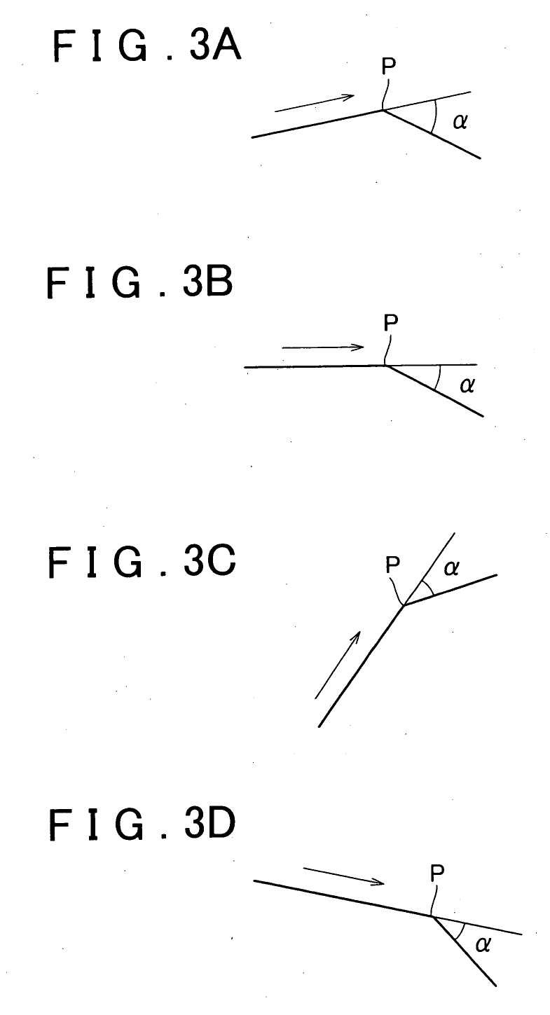

Each of FIGS. 3A-3D illustrates a lateral view showing an example of a change of a road inclination of a to-be-taken road with respect to a road inclination of a cruising road, the change impairing driver's visibility. In each of FIGS. 3A-3D, an arrow indicates the direction in which the vehicle is proceeding. Reference character “P” shows a point at which the road inclination of the to-be-taken road changes with respect to the road inclination of the cruising road (hereinafter, referred to as a “road inclination changing point”).

In FIG. 3A, the cruising road is an uphill road, the to-be-taken-road is a downhill road, and an amount of change of the road inclination of the to-be-taken road with respect to the road inclination of the cruising road is “α”. In FIG. 3B, the cruising road is a flat road, the to-be-taken-road is a downhill road, and an amount of change of the road inclination of the to-be-taken road with respect to the road inclination of the cruising road is “α”. In FIG. 3C, the cruising road is an uphill road, the to-be-taken-road is also an uphill road, and an amount of change of the road inclination of the to-be-taken road with respect to the road inclination of the cruising road is “α”. In FIG. 3D, the cruising road is a downhill road, the to-be-taken-road is also a downhill road, and an amount of change of the road inclination of the to-be-taken road with respect to the road inclination of the cruising road is “α”.

In each of the cases shown in FIGS. 3A-3D, if the change amount “α” is larger than the predetermined value (α>predetermined value), an affirmative determination is made in step S30.

As shown in FIGS. 3A-3D, at a point before the road inclination changing point P, the driver's visibility of an area ahead of the road inclination changing point P is low. At the point before the road inclination changing point P, it is impossible or difficult for the driver to visually check the area ahead of the road inclination changing point P. Accordingly, the driver cannot recognize the condition of the road located ahead of the road inclination changing point P, and is therefore likely to feel anxious. When a driver's intention to decelerate the vehicle is detected (“YES” in step S20), it is desirable that the deceleration of the vehicle be made higher than the deceleration in the case where it is easy for the driver to visually check the area ahead of the vehicle.

Even when the road inclination of the road located before the road inclination changing point P is the same, the appropriate deceleration required when a driver's intention to decelerate the vehicle is detected varies depending on the road inclination of the road located ahead of the road inclination changing point P. Two cases in each of which the road located before the road inclination changing point P is a flat road are taken as examples. In the first example shown in FIG. 3B, the road located ahead of the road inclination changing point P is a downhill road, and an amount of change of the road inclination of the road located ahead of the road inclination changing point P with respect to the road inclination of the road located before the road inclination changing point P is “α”. In the second example (not shown), the road located ahead of the road inclination changing point P is an uphill road or a downhill road, and in the case of the downhill road, the change of the road inclination of the road located ahead of the road inclination changing point P with respect to the road inclination of the road located before the road inclination changing point P is considerably small. On the road in the second example, since the driver's visibility of the area ahead of the road inclination changing point P is good, the driver does not feel anxious. On the other hand, on the road in the first example, since the driver's visibility of the area ahead of the road inclination changing point P is poor, the driver feels anxious. Therefore, when a driver's intention to decelerate the vehicle is detected due to the anxiety of the driver, it is desirable to cause a large amount of deceleration.

In step S30, the control circuit 30 determines whether there is a change of the road inclination of the to-be-taken road with respect to the road inclination of the cruising road, the change impairing the driver's visibility of the area ahead of the road inclination changing point P, based on the information concerning the road inclination of the to-be-taken road, which is received from the navigation system unit 95, and the information concerning the road inclination of the cruising road, which is received from the road inclination measuring/estimating portion 118. The information concerning the road inclination of the to-be-taken road may be the information concerning the road inclination which was obtained stored in the memory of the vehicle when the vehicle ran on the same road in the past, in addition to the information received from the navigation system unit 95. When an affirmative determination is made in step S30, step S40 is then performed. On the other hand, when a negative determination is made in step S30, step S60 is then performed.

In step S40, the control circuit 130 determines whether a distance between the present vehicle position and the road inclination changing point P is equal to or shorter than a predetermined distance. The predetermined distance is stored in the ROM 133 in advance. The predetermined distance may be a value variable based on a vehicle speed, as described later in detail. The control circuit 130 can recognize the distance between the present vehicle position and the road inclination changing point P based on the information received from the navigation system unit 95. When an affirmative determination is made in step S40, step S60 is performed. On the other hand, when a negative determination is made in step S40, step S50 is performed.

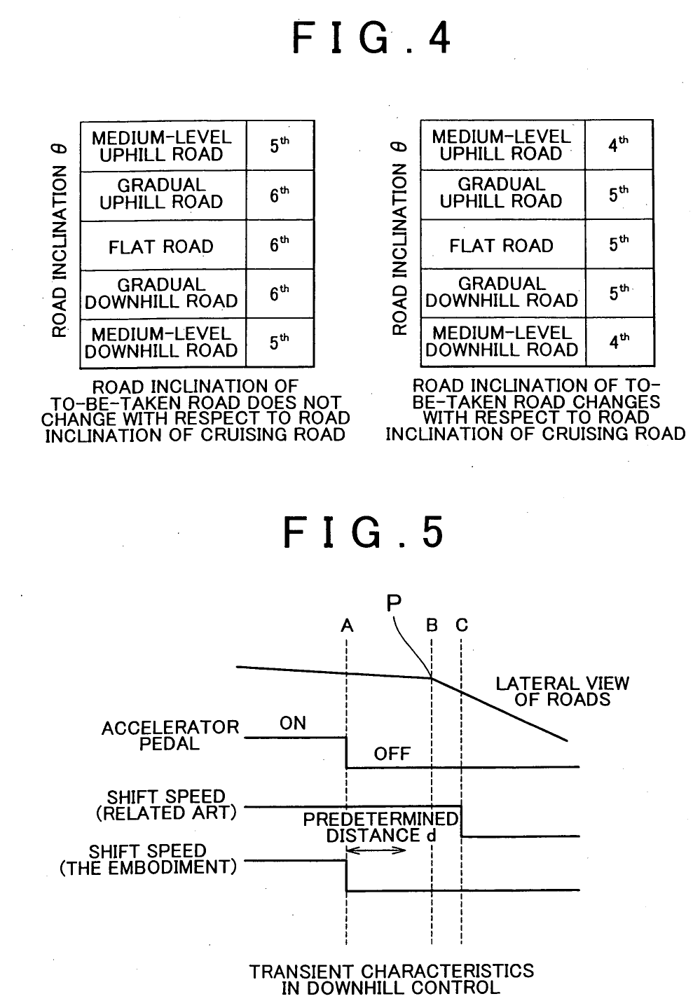

In step S50, the control circuit 130 changes a threshold value for the downhill control to a value at which downshifting of the automatic transmission 10 is more easily performed (not shown), or changes a shift speed map to a shift speed map based on which a lower shift speed is selected (FIG. 4). Namely, the threshold value is changed from the default threshold value to the threshold value at which downshifting is more easily performed. Alternatively, the shift speed map is changed from the default shift speed map to the shift speed map based on which a lower shift speed is selected.

FIG. 4 shows shift speed maps selected in step S50. The map on the left side in FIG. 4 is a shift speed map (default map) which is used when the shift speed map is not changed (i.e., when step S50 is not performed) (“NO” in step S30, or “YES” in step S40). The map on the right side in FIG. 4 is a shift speed map used after the shift speed map is changed in step S50 (“NO” in step S40).

As shown in FIG. 4, when the shift speed map is changed in step S50, if the road inclination of the cruising road does not change between before and after the shift speed map is changed, the shift speed selected based on the shift speed map used after the change is lower than the shift speed selected based on the shift speed map before the change (default map). After step S50 is completed, step S60 is performed.

When it is determined in step S40 that the distance between the present vehicle position and the road inclination changing point P is equal to or shorter than the predetermined distance (“YES” in step S40) and step S60 is then performed without performing step S50, the default threshold value or the default shift speed map (the map on the left side in FIG. 4) is used in step S60.

When it is determined in step S40 that the distance between the present vehicle position and the road inclination changing point P is equal to or shorter than the predetermined distance (“YES” in step S40), the threshold value is not changed and the default threshold value is used, or the shift speed map is not changed and the default shift speed map is used, for the following reasons. When the distance between the present vehicle position and the road inclination changing point P is short (i.e., equal to or shorter than the predetermined distance), the driver can recognize a change of the road inclination of the to-be-taken road (ahead of the road inclination changing point P) with respect to the road inclination of the cruising road, and therefore does not feel anxious. Also, a time between when a shifting instruction is given and when shifting is completed (i.e., when a large amount of deceleration is caused by a low shift speed) is long. Accordingly, when the shifting is completed, the vehicle has already passed the road inclination changing area (the road inclination changing point P). Therefore, the predetermined distance used in step S40 may be variable based on the vehicle speed (as the vehicle speed increases, the predetermined distance used in step S40 is set to a longer distance).

In step S60, the control circuit 130 determines whether shift speed needs to be changed. The control circuit 130 refers to the shift speed map in FIG. 4 (when the shift speed map is changed in step S50, the control circuit 130 refers to the shift speed map on the right side in FIG. 4, and when the shift speed is not changed (i.e., step S50 is not performed), the control circuit 130 refers to the shift speed map on the left side in FIG. 4). Then, the control circuit 130 compares the shift speed corresponding to the road inclination of the cruising road, shown in the shift speed map, with the present shift speed, thereby determining whether the shift speed needs to be changed. The control circuit 130 may refer to the threshold value for the downhill control instead of, or in addition to, referring to the shift speed map. Then, the control circuit 130 may compare the shift speed corresponding to the road inclination of the cruising road with the present shift speed, thereby determining whether the shift speed needs to be changed.

In step S60, for example, in the case where the shift speed corresponding to the road inclination of the cruising road is determined to be fifth speed with reference to the shift speed map in FIG. 4 and/or the threshold value for the downhill control, and the present shift speed is sixth speed, the control circuit 130 determines that shifting (downshifting from sixth speed to fifth speed) needs to be performed.

In step S60, in some cases, the control circuit 130 determines that upshifting needs to be performed as a result of comparison of the shift speed corresponding to the road inclination of the cruising road with the present shift speed. The restriction placed on upshifting is removed in step S140 in the control routine performed last time. Therefore, in step S60, a determination that upshifting needs to be performed is made in some cases.

When an affirmative determination is made in step S60, step S70 is performed. On the other hand, when a negative determination is made in step S60, the control routine is reset. The description concerning the first embodiment will be made on the assumption that it is determined that downshifting from sixth speed to fifth speed needs to be performed.

After the control circuit 130 decides, in step S60, the shift speed (fifth speed) to be achieved, an instruction to change the shift speed to the decided shift speed is given in step S70. Namely, a downshifting instruction (shifting instruction) is output from the CPU 131 of the control circuit 130 to the electromagnetic valve driving portions 138a, 138b, and 138c. In response to the downshifting instruction, the electromagnetic valve driving portions 138a, 138b, and 138c energize/de-energize the electromagnetic valves 121a, 121b, and 121c, respectively. Thus, the automatic transmission 10 performs shifting according to the downshifting instruction. After step S70 is completed, step S80 is performed.

In step S80, the control circuit 130 determines whether the threshold value or the shift speed map was changed in step S50. When an affirmative determination is made in step S80, step S90 is performed. On the other hand, when a negative determination is made in step S80, the control routine is reset. In the first embodiment, since the threshold value or the shift speed map is changed in step S50, step S90 is then performed.

In step S90, the control circuit 130 determines whether the vehicle has passed the road inclination changing point P. The control circuit 130 can determine whether the vehicle has passed the road inclination changing point P based on the information received from the navigation system unit 95. When it is determined in step S90 that the vehicle has not passed the road inclination changing point P (“NO” in step S90), the flag F is set to “1” in step S160, after which the control routine is reset. Then, steps S10 to S80 are repeatedly performed until an affirmative determination is made in step S90. On the other hand, when it is determined in step S90 that the vehicle has passed the road inclination changing point P (“YES” in step S90), step S100 is then performed.

In step S100, the control circuit 130 changes the threshold value to the default threshold value or changes the shift speed map to the default shift speed map. After step S100 is completed, step S110 is performed.

In step S110, the control circuit 130 restricts upshifting. Upshifting is restricted in step S110 for the following reason.

The situation illustrated in FIG. 3B, wherein the road located ahead of the road inclination changing point P is a downhill road whose inclination is gentle, is taken as an example. As described above, when the vehicle has passed the road inclination changing point P (“YES” in step S90) and the threshold value is changed to the default threshold value or the shift speed map is changed to the default shift speed map in step S100, upshifting may be performed based on the default threshold value or the default shift speed map. Namely, the shift speed map is changed in step S50 (refer to the shift speed map on the right side in FIG. 4), and therefore downshifting from sixth speed to fifth speed is performed in step S70 at a point on the flat road located before the road inclination changing point P after an affirmative determination is made in step S60. Then, if the shift speed map is changed to the default shift speed map in step S100 after the vehicle has passed the road inclination changing point P (refer to the shift speed map on the left side in FIG. 4), upshifting from fifth speed to sixth speed is performed at a point on the downhill road whose inclination is gentle, which is ahead of the road inclination changing point P.

If upshifting is performed immediately after the threshold value is changed to the default threshold value or the shift speed map is changed to the default shift speed map in step S100, the driver feels a sense of discomfort. Therefore, after the threshold value is changed to the default threshold value or the shift speed map is changed to the default shift speed map in step S100, upshifting is restricted in step S110. After step S110 is completed, step S120 is performed.

In step S120, the control circuit 130 sets the flag F to “2”. After step S120 is completed, step S130 is performed.

In step S130, the control circuit 130 determines whether the accelerator pedal is fully released. When it is determined in step S130 that the accelerator pedal is fully released (“YES” in step S130), the control routine is reset, and step S10 and the following steps are repeatedly performed until a negative determination is made in step S130. On the other hand, when it is not determined in step S130 that the accelerator pedal is fully released (“NO” in step S130), step S140 is then performed. When a negative determination is made in step S130, it is determined that the driver does not have an intention to decelerate the vehicle. Accordingly, the restriction placed on upshifting is removed in step S140. Then, the flag F is reset to “0” in step S150, after which the control routine is reset.

An example of the control will be described with reference to FIG. 5. The description is made on the assumption that the accelerator pedal is released at a point A (FIG. 5) on a downhill road whose inclination is gentle. Conventionally, namely, according to the default threshold value or the shift speed map, downshifting is not performed. Namely, when the control is performed based on the default threshold value for the downhill control or the default shift speed map, downshifting is not performed until the vehicle reaches a point C on the downhill road whose inclination is steeper.

In contrast to this, in the first embodiment, when the accelerator pedal is fully released at the point A (“YES” in step S20), a change of the road inclination of the to-be-taken road with respect to the road inclination of the cruising road, which occurs at a point B located ahead of the present point A by a predetermined distance d (inclination changing point P) is detected (“YES” in step S30, “NO” in step S40, step S50) and downshifting is performed at the point A due to a release of the accelerator pedal (“YES” in step S60, step S70). Therefore, deceleration is increased from the point at which the accelerator pedal is released, which is located before the road inclination changing point P. Accordingly, even when the driver's visibility is impaired due to the change of the road inclination of the to-be-taken road with respect to the road inclination of the cruise road, the driver can drive the vehicle without anxiety.

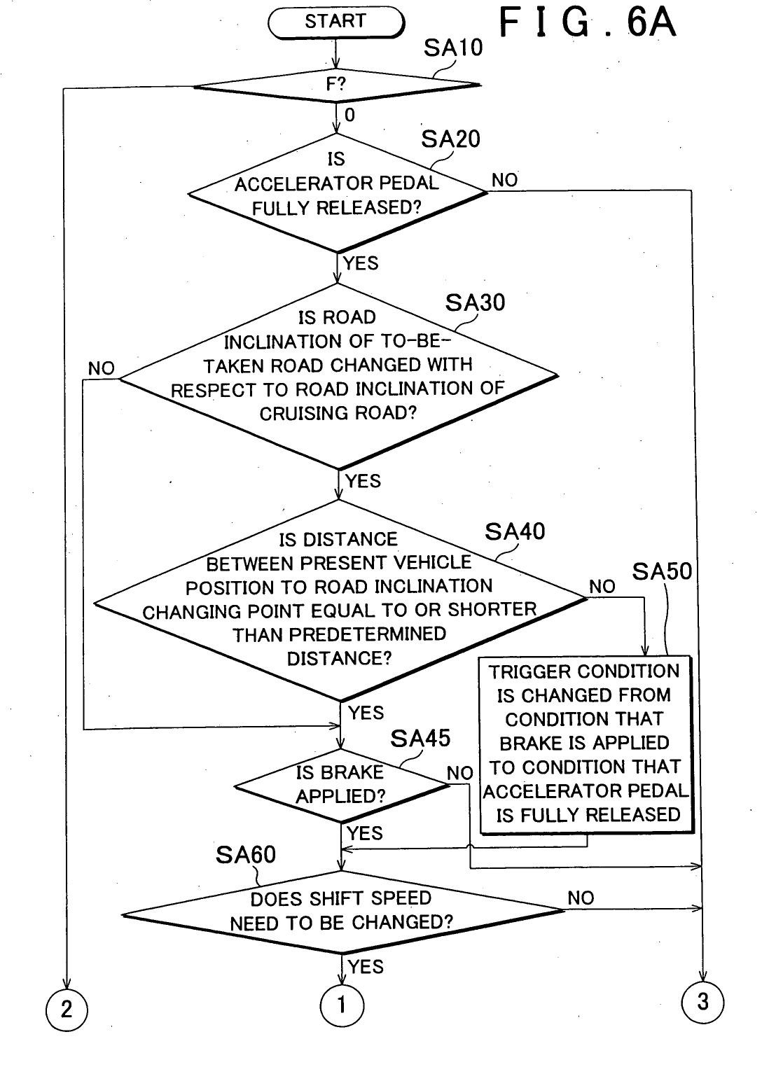

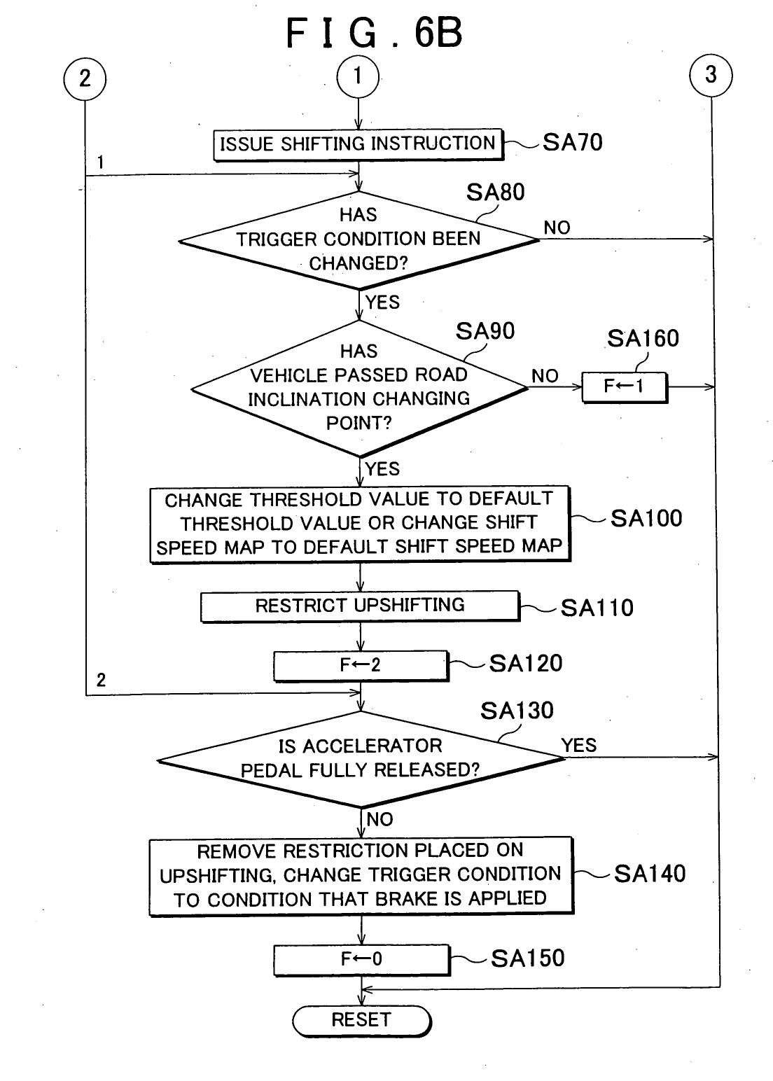

Next, a second embodiment of the invention will be described with reference to FIGS. 6A and 6B. The steps in the second embodiment, which are similar to those in the first embodiment, will not be described here.

In the first embodiment, a condition under which for the downhill control is started (hereinafter, referred to as a “trigger condition”) is a condition that the accelerator pedal is fully released (“YES” in step S20). When there is a change of the road inclination of the to-be-taken road with respect to the road inclination of the cruising road, the change impairing the driver's visibility (“YES” in step S30), and the distance between the present vehicle position and the road inclination changing point P is longer than the predetermined distance (“NO” in step S40), the threshold value or the shift speed map is changed in step S50.

By contrast, in the second embodiment, basically, the trigger condition for the downhill control is a condition that a brake is applied (“YES” in step SA45). When there is a change of the road inclination of the to-be-taken road with respect to the road inclination of the cruising road, the change impairing the driver's visibility (“YES” in step SA30), and the distance between the present vehicle position and the road inclination changing point P is longer than the predetermined distance (“NO” in step SA40), the trigger condition is changed in step SA50 from the condition that the brake is applied to the condition that the accelerator pedal is fully released. Changing the trigger condition from the condition that the brake is applied to the condition that the accelerator pedal is fully released makes it easier to perform downshifting.

Since steps SA10 to SA40 in FIGS. 6A and 6B are the same as steps S10 to S40 in FIGS. 1A and 1B, respectively, description concerning steps SA10 to SA 40 are not made here. Also, since step SA60, step SA70, step SA90, steps SA100 to SA130, and steps SA150 and SA160 in FIG. 6 are the same as step S60, step S70, step S90, steps S100 to S130, and steps S150 and S160 in FIGS. 1A and 1B, respectively, description concerning step SA60, step SA70, step SA90, steps SA100 to SA130, and steps SA150 and SA160 will not be made here.

Note that the determination, in step SA20, as to whether the accelerator pedal is fully released is not made to determine whether the trigger condition for the downhill control is satisfied, but rather to determine whether the precondition for the downhill control is satisfied.

First, a description will be made concerning the normal case in the second embodiment, that is, the case in which there is no change of the road inclination of the to-be-taken road with respect to the road inclination of the cruising road, the change impairing the driver's visibility (“NO” in step SA30).

In the normal case, that is, in the case there is no change of the road inclination of the to-be-taken road with respect to the road inclination of the cruising road, the change impairing the driver's visibility (“NO” in step SA30), or in the case where the distance between present vehicle position and the road inclination changing point P is equal to or shorter than the predetermined distance (“YES” in step SA40), the trigger condition is the condition that the brake is applied (step SA45).

When the fact that the brake is applied is detected (“YES” in step SA45), it is determined in SA 60 whether the shift speed needs to be changed based on the threshold value for the downhill control or the shift speed map. When it is determined that the shift speed needs to be changed (“YES” in step SA60), shifting is performed in step SA70. After shifting is performed, it is determined in step SA80 whether the trigger condition is changed. In the second embodiment, the trigger condition is maintained at the condition that the brake is applied (namely, the trigger condition has not been changed to the condition that the accelerator pedal is fully released) (“NO” in step SA80). Therefore, the control routine is reset.

Next, description will be made concerning the case in which there is a change of the road inclination of the to-be-taken road with respect to the road inclination of the cruising road, the change impairing the driver's visibility (“YES” in step SA30).

When there is a change of the road inclination of the to-be-taken road with respect to the road inclination of the cruising road, the change impairing the driver's visibility (“YES” in step SA30), it is then determined in step SA40 whether the distance between the present vehicle position and the road inclination changing point P is equal to or shorter than the predetermined distance. When it is determined that the distance between the present vehicle position and the road inclination changing point P is longer than the predetermined distance (“NO” in step SA40), the trigger condition is changed in step SA50 from the condition that the brake is applied to the condition that the accelerator pedal is fully released.

The time point at which the trigger condition is changed, in step SA50, to the condition that the accelerator pedal is fully released is substantially the same as the time point at which it is determined in step SA20 that the accelerator pedal is fully released. Accordingly, upon changing the trigger condition, in step SA50, to the condition that the accelerator pedal is fully released, the trigger condition is satisfied (a driver's intention to decelerate the vehicle is detected).

In the case where the trigger condition is the condition that the accelerator pedal is fully released (“YES” in step SA50), the trigger condition is satisfied easily, as compared to the case in which the trigger condition is the condition that the brake is applied (“YES” in step SA45). Accordingly, when there is a change of the road inclination of the to-be-taken road with respect to the road inclination of the cruising road, the change impairing the driver's visibility (“YES” in step SA30) and the distance between the present vehicle position and the road inclination changing point P is longer than the predetermined distance (“NO” in step SA40), downshifting by the downhill control can be performed easily.

In step SA60, it is determined whether the shift speed needs to be changed based on the threshold value for the downhill control or the shift speed map. When it is determined in step SA60 that the shift speed needs to be changed (“YES” in step SA60), shifting is performed in step SA70. After shifting is performed, it is determined in step SA80 whether the trigger condition has been changed. In the second embodiment, since the trigger condition has been changed to the condition that the accelerator pedal is fully released (“YES” in step SA80), step SA90 is then performed.

The operation in step SA90 and the following steps are the same as the operation in step S90 and the following steps in FIG. 1B, except that in the second embodiment, the trigger condition is returned, in step SAl40, to the condition that the brake is applied when restriction placed on upshifting is removed.

According to the second embodiment, the trigger condition is the condition that the brake is applied, when the vehicle is decelerating. By contrast, when there is a change of the road inclination of the to-be-taken road with respect to the road inclination of the cruising road, the change impairing the driver's visibility (“YES” in step SA30) and the distance between the present vehicle position and the road inclination changing point P is longer than the predetermined distance (“NO” in step SA40), the trigger condition is changed to the condition that the accelerator pedal is fully released. Accordingly, downshifting by the downhill control can be performed easily.

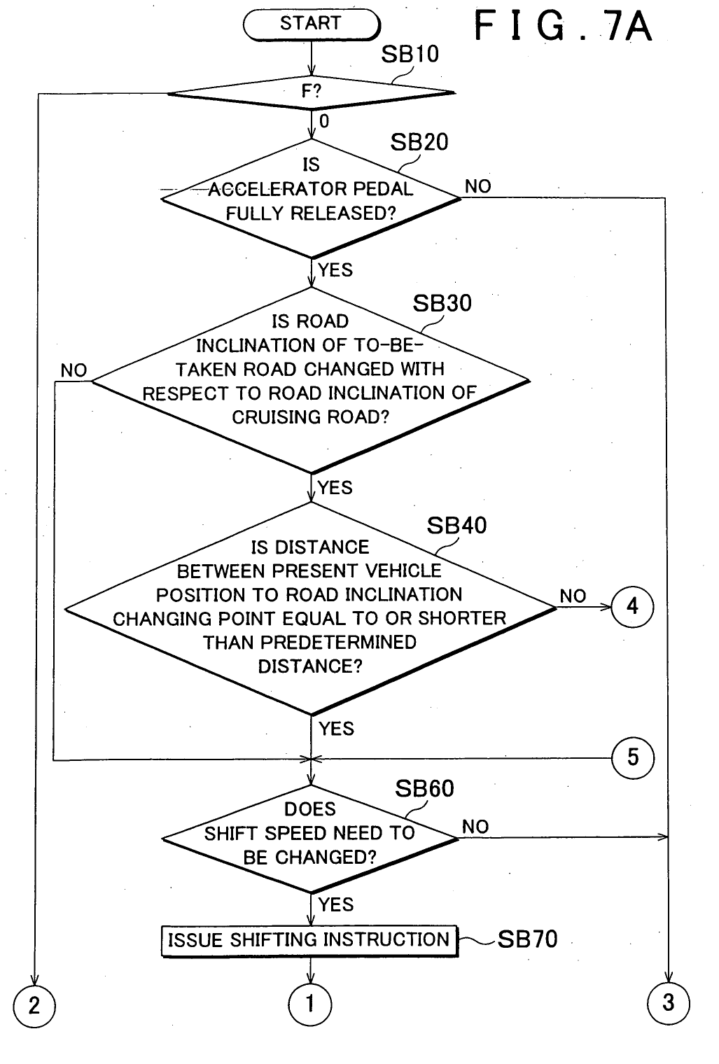

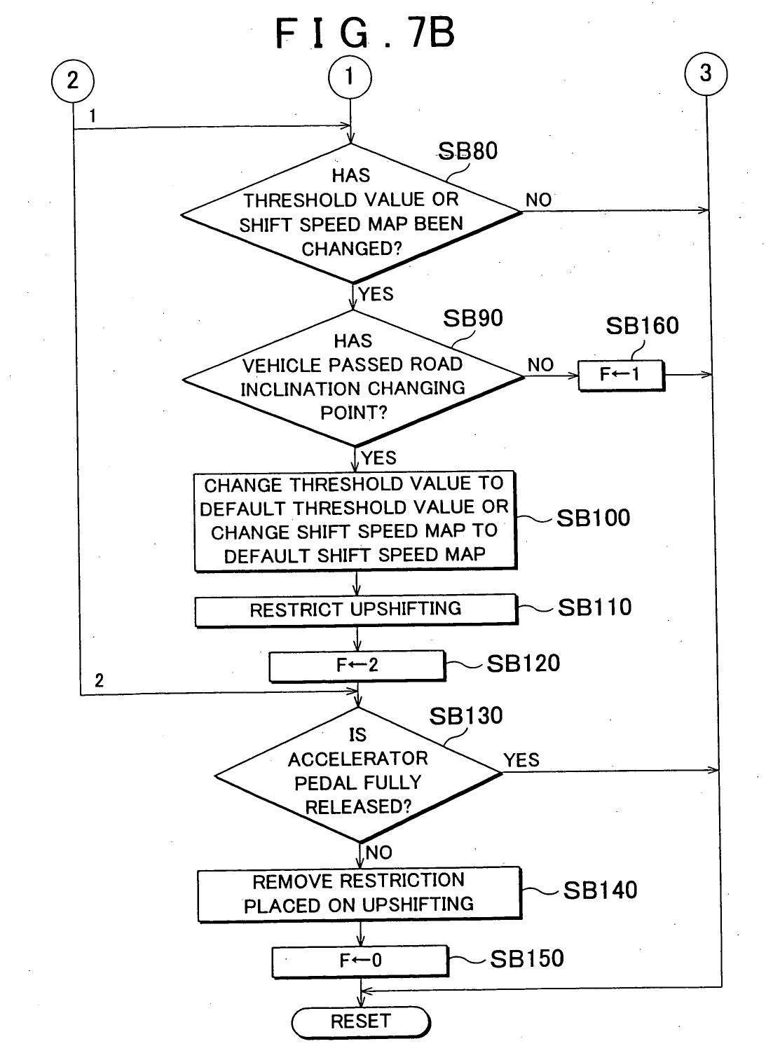

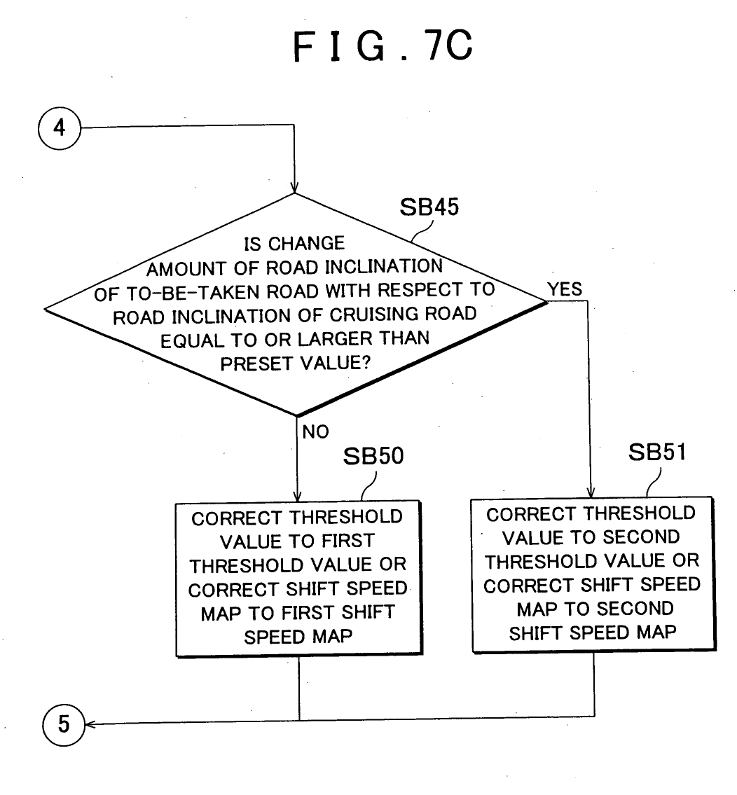

Next, a third embodiment of the invention will be described with reference to FIGS. 7A, 7B, and 7C. The steps in the third embodiment, which are similar to those in the first embodiment, will not be described here.

The control routine according to the third embodiment is similar to the control routine according to the first embodiment (FIGS. 1A and 1B) except that step SB45 and step SB51 are set in the control routine in the third embodiment. When there is a change of the road inclination of the to-be-taken road with respect to the road inclination of the cruising road, the change impairing the driver's visibility (“YES” in step SB30) and the distance between the present vehicle position and the road inclination changing point P is longer than the predetermined distance (“NO” in step SB40), it is determined in step SB45 whether the amount of change of the road inclination of the to-be-taken road with respect to the road inclination of the cruising road, the change impairing the driver's visibility (change rate, deviation of inclination), is equal to or larger than a preset value. The preset value is larger than the predetermined value used in step S30 and it is stored in the ROM 133 in advance.

When it is determined in step SB45 that the amount of change of the road inclination of the to-be-taken road with respect to the road inclination of the cruising road, the change impairing the driver's visibility, is equal to or larger than the preset value (“YES” in step SB45), the threshold value for the downhill control is changed to a second threshold value, or the shift speed map is changed to a second shift speed map. On the other hand, when it is determined in step SB45 that the amount of change of the road inclination of the to-be-taken road with respect to the road inclination of the cruising road, the change impairing the driver's visibility, is smaller than the preset value (“NO” in step SB45), the threshold value for the downhill control is changed to a first threshold value, or the shift speed map is changed to a first shift speed map.

Each of the first threshold value and the second threshold values is a value at which downshifting of the automatic transmission 10 can be performed easily, as compared to the default threshold value. Note that the second threshold value is a value at which downshifting of the automatic transmission 10 can be performed easily, as compared to the first threshold value. Each of the first shift speed map and the second shift speed map is a map based on which a low shift speed is selected, as compared to the default shift speed map. Note that the second shift speed map is a map based on which a low shift speed is selected, as compared to the first shift speed map.

Since steps SB10 to SB40 in FIGS. 7A, 7B, and 7C are the same as steps S10 to S40 in FIGS. 1A and 1B, respectively, description concerning steps SB10 to SB40 will not be made here. Also, since steps SB60 to SB160 in FIG. 7 are the same as steps S60 to S160 in FIGS. 1A and 1B, respectively, description concerning steps SB60 to SB160 will not be made here.

According to the third embodiment, deceleration to be caused can be changed based on the amount of change of the road inclination of the to-be-taken road with respect to the road inclination of the cruising road, the change impairing the driver's visibility. It is therefore possible to cause deceleration appropriate for the driver.

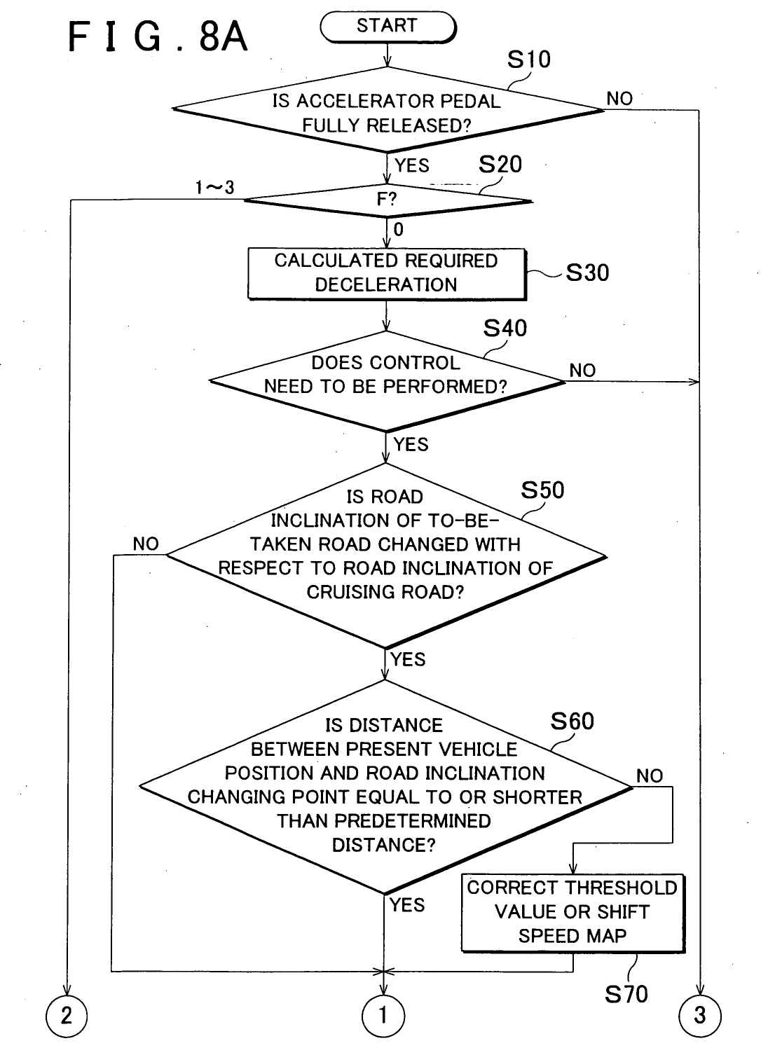

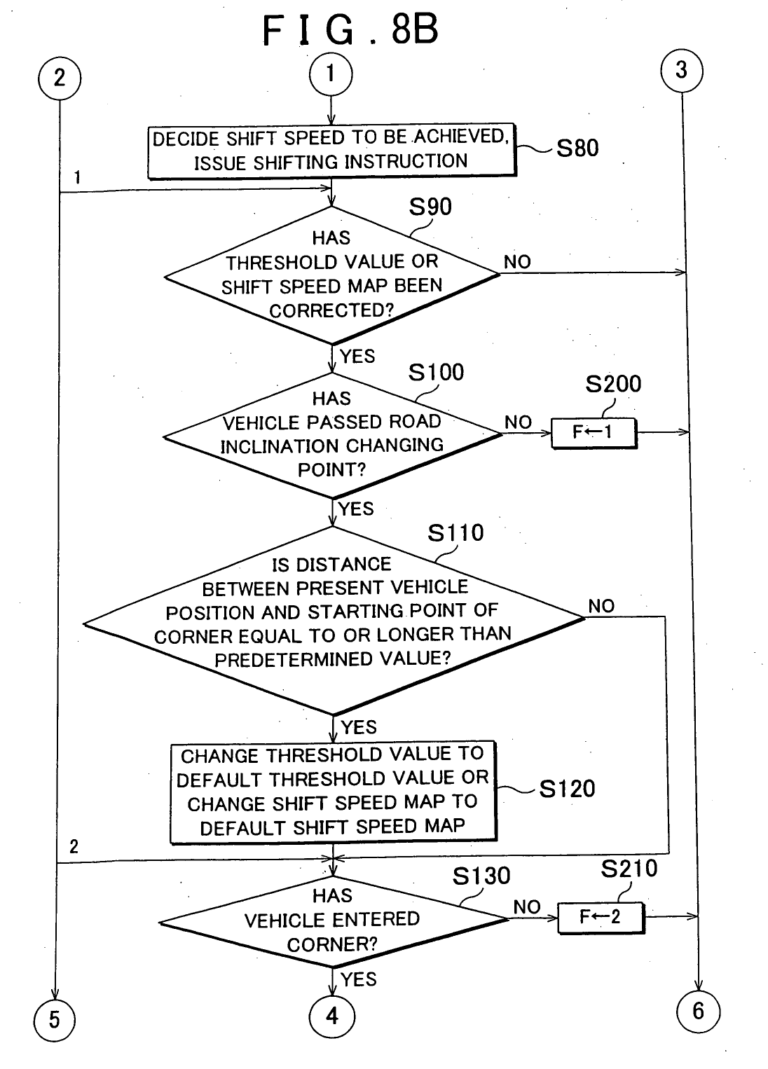

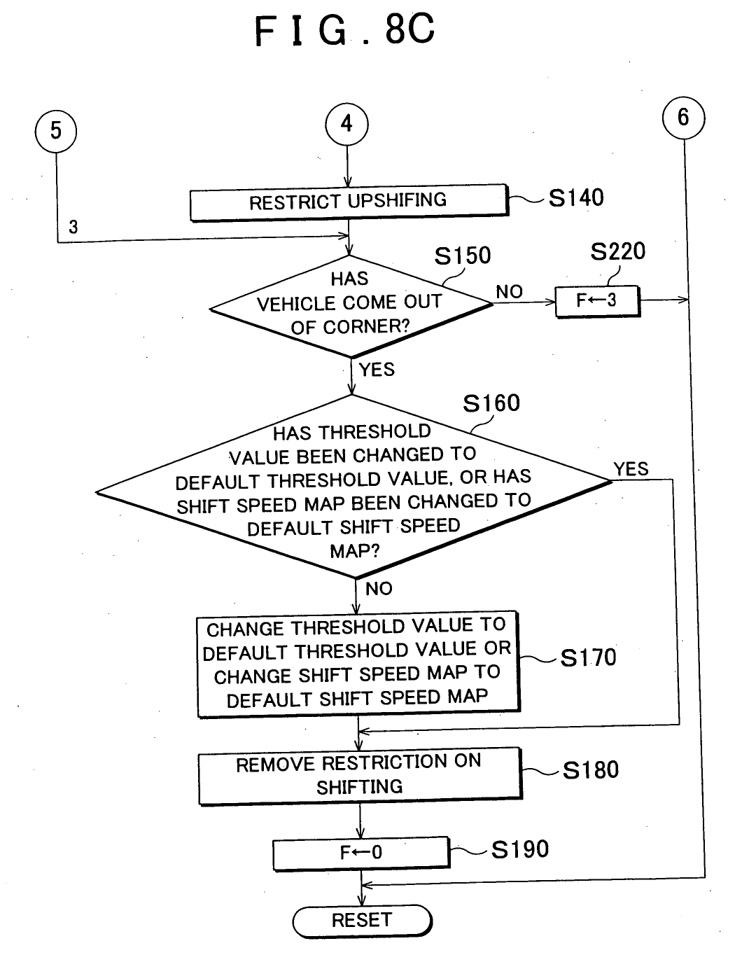

Next, a fourth embodiment of the invention will be described with reference to FIGS. 8A-8C and 9-11. The steps in the fourth embodiment, which are similar to those in the first embodiment, will not be described here.

The fourth embodiment relates to a deceleration control apparatus for a vehicle, which controls the automatic transmission based on a curvature radius R of a corner and a road inclination of a road located ahead of the vehicle, thereby realizing a desired deceleration.

As described later in detail, in the fourth embodiment, there are provided a transmission which can change a shift speed; a transmission control device which controls the transmission; a corner detector which detects a corner (e.g., the curvature radius R of the corner and a distance between the present vehicle position and the starting point of the corner); a road inclination detector which detects a road inclination; and a device which controls the transmission control device based on the detection results obtained by the corner detector and the road inclination detector.

An operation according to the fourth embodiment will be described with reference to FIGS. 8A, 8B, and 8C, and FIG. 11. FIG. 11 illustrates a chart for describing the deceleration control according to the fourth embodiment. FIG. 11 shows a control performing boundary line L, a required deceleration 401, a top view of a road shape, and an accelerator pedal operation amount 301.

At a time point 407 indicated by a reference character “A” in FIG. 11, the accelerator pedal is fully released (the accelerator pedal operation amount is “0”), as shown by the reference numeral 301.

In step S10, the control circuit 130 determines whether the accelerator pedal is fully released based on a signal from the throttle valve opening amount sensor 114. When it is determined in step S10 that the accelerator pedal is fully released, step S20 is performed. When the accelerator pedal is fully released (“YES” in step S10), it is determined that the driver intends to decelerate the vehicle, and the deceleration control according to the fourth embodiment is performed. On the other hand, when it is not determined that the accelerator pedal is fully released, the control routine is reset. As described above, the accelerator pedal opening amount 301 is made “0” (the accelerator pedal is fully released) at the time point A in FIG. 11.

In step S20, the control circuit 130 checks the flag F. When the flag F shows “0”, step S30 is performed. When the flag F shows “1”, step S90 is performed. When the flag F shows “2”, step S130 is performed. When the flag F shows “3”, step S150 is performed. When the control routine is performed, the flag F initially shows “0”. Therefore, step S30 is then performed.

In step S30, the control circuit 130 calculates a required deceleration. The required deceleration is the deceleration required to turn the corner located ahead of the vehicle at a predetermined and desired turning acceleration G (to enter the corner at a desired vehicle speed). In FIG. 11, the required deceleration is shown by the reference numeral 401.

In FIG. 11, the horizontal axis indicates a distance between the present vehicle position and the corner. As shown by the top view of the road shape, a corner 402 located ahead of the vehicle extends from a starting point 403 indicated by a reference character “E” to an ending point 404 indicated by a reference character “G”. In order to turn the corner 402 at the predetermined and desired turning acceleration G, the vehicle speed needs to be reduced to a target vehicle speed 406 corresponding to a curvature radius R405 of the corner 402 at the starting point 403 of the corner 402. Namely, the target vehicle speed 406 is a value corresponding to the curvature radius R 405 of the corner 402.

In order to reduce the vehicle speed from the vehicle speed at the point 407 indicated by the reference character “A”, at which it is determined in step S10 that the accelerator pedal is fully released, to the target vehicle speed 406 that is required at the starting point 403 of the corner 402, deceleration indicated by the required deceleration 401 needs to be achieved. The control circuit 130 calculates the required deceleration 401 based on the present vehicle speed received from the vehicle speed sensor 122, the distance between the present vehicle position and the starting point 403 of the corner 402, received from the navigation system unit 95, and the curvature radius R 405 of the corner 402.

A description will be made on the assumption that there is a corner whose curvature radius R is smaller than the curvature radius R405 of the corner 402 (hereinafter, referred to as a “virtual corner”) (not shown) in FIG. 11. For the sake of comparison, the virtual corner has a starting point at the same position as the starting point 403 of the corner 402. At the starting point 403 of the virtual corner, the vehicle speed needs to be reduced to a vehicle speed 406v that is lower than the target vehicle speed 406 to be achieved at the corner 402, since the curvature radius R of the virtual corner is smaller than the curvature radius R405 of the corner 402. The required deceleration at the virtual corner is indicated by a reference numeral 401v. The required deceleration at the virtual corner is higher than the required deceleration 401.

When the control circuit 130 determines in step S30 that there is no corner ahead of the vehicle based on the data received from the navigation system unit 95, the required deceleration is not calculated. After step S30 is completed, step S40 is performed.

In step S40, the control circuit 130 determines whether the control needs to be performed based on, for example, the control performing boundary line L. If the point indicating the relationship between the present vehicle speed and the distance between the present vehicle position and the starting point 403 of the corner 402 is on the upper side of the control performing boundary line L in FIG. 11, it is determined that the control needs to be performed. On the other hand, if the point indicating the relationship between the present vehicle speed and the distance between the present vehicle position and the starting point 403 of the corner 402 is on the lower side of the control performing boundary line L, it is determined that the control need not be performed. When an affirmative determination is made in step S40, step S50 is performed. On the other hand, when a negative determination is made in step S40, the control routine is reset.

The control performing boundary line L is a line that indicates the relationship between the present vehicle speed and the distance between the present vehicle position and the entrance 403 of the corner 402, and that corresponds to the lower limit of the range in which the target vehicle speed 406 cannot be achieved at the starting point 403 of the corner 402 unless the deceleration higher than the predetermined deceleration obtained by a normal braking operation is applied to the vehicle (the vehicle cannot turn the corner 402 at the predetermined turning acceleration G). Namely, when the point indicating the above-mentioned relationship is on the upper side of the control performing boundary line L, the deceleration higher than the predetermined deceleration obtained by a normal braking operation needs to be applied to the vehicle in order to achieve the target deceleration 406 at the starting point 403 of the corner 402.

Therefore, when the point indicating the above-mentioned relationship is on the upper side of the control performing boundary line L, the deceleration control based on the curvature radius R in the fourth embodiment is performed in step S80. Accordingly, it is possible to achieve the target deceleration 406 at the starting point 403 of the corner 402 due to the increase in the deceleration, even when the driver does not apply the brake, or even when the brake operation amount is relatively small (even when the driver depresses the foot brake by a little amount).

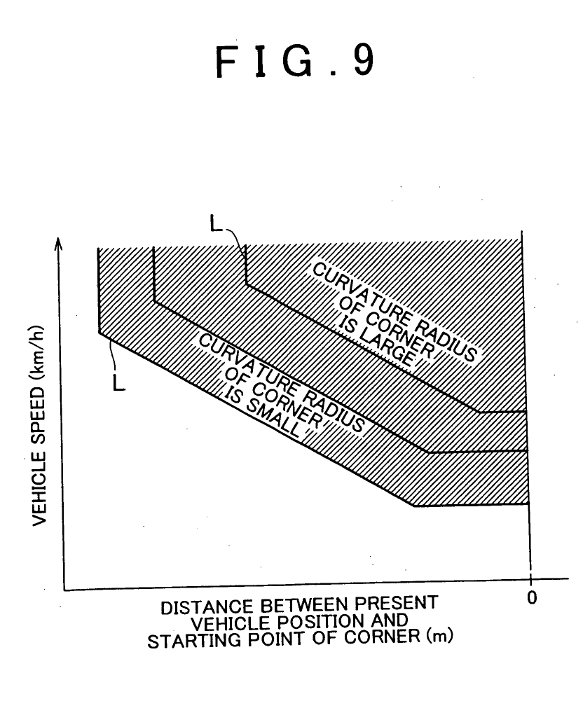

FIG. 9 is a graph for describing the control performing boundary line L. The shaded region in FIG. 9 shows a deceleration region that is calculated based on the target deceleration 406 decided by the curvature radius R of the corner 402 of the road located ahead of the vehicle in the direction in which the vehicle proceeds. The deceleration region is set on the side on which the vehicle speed is high and the distance between the present vehicle position and the starting point of the corner is short. The control performing boundary line L indicating the boundary of the deceleration region is set so as to be closer to the side on which the vehicle speed is high and the distance between the present vehicle position and the starting point of the corner 402 is short, as the curvature radius R of the corner 402 increases. When the point indicating the relationship between the actual speed of the vehicle running on the road before the corner and the distance between the present vehicle position and the starting point of the corner exceeds the control performing boundary line L in FIG. 9, the deceleration control based on the curvature radius R according to the fourth embodiment is performed.

As the control performing boundary line L in the fourth embodiment, the control performing boundary line used for the conventional shift point control based on the curvature radius R can be used as it is. The control performing boundary line L is prepared by the control circuit 130 based on the data indicating the curvature radius R 405 of the corner 402 and the distance between the present vehicle position and the starting point of the corner 402.

In the fourth embodiment, the point (point 407) indicated by the reference character A at which the accelerator pedal operation amount 301 is made “0” is on the upper side of the control performing boundary line L in FIG. 11. Therefore, it is determined that the control needs to be performed (“YES” in step S40), after which step S50 is performed. The description has been made concerning the case in which it is determined in step S40 whether the deceleration control based on the curvature radius R according to the fourth embodiment needs to be performed. However, whether the deceleration control based on the curvature radius R is performed according to the fourth embodiment may be determined based on elements other than the control performing boundary line L.

Step S50 is the same as step S30 in FIG. 1A. Namely, it is determined in step S50 whether there is a change of the road inclination of the to-be-taken road with respect to the road inclination of the cruising road, the change impairing the driver's visibility, ahead of the vehicle. The state in which there is the change impairing the driver's visibility signifies the state in which the road inclination of the to-be-taken road is changed with respect to the road inclination of the cruising road by at least a predetermined value, the change corresponding to a downhill inclination with respect to the cruising road. The predetermined value is stored in the ROM 133 in advance.

In step S50, the control circuit 130 determines whether there is a change of the road inclination of the to-be-taken road with respect to the road inclination of the cruising road, the change impairing the driver's visibility, based on the information concerning the road inclination of the to-be-taken road, which is received from the navigation system unit 95, and the information concerning the road inclination of the cruising road, which is obtained by the road inclination measuring/estimating portion 118. The information concerning the road inclination of to-be-taken road may be the information concerning the road inclination which is obtained and stored in the memory of the vehicle when the vehicle ran the to-be-taken road in the past, in addition to the information received from the navigation system unit 95. When an affirmative determination is made in step S50, step S60 is performed. On the other hand, when a negative determination is made in step S50, step S80 is performed.

Step S60 is the same as step S40 in FIG. 1A. Namely, the control circuit 130 determines whether the distance between the present vehicle position and the road inclination changing point P is equal to or shorter than the predetermined distance. The predetermined distance is stored in the ROM 133 in advance. As described above, the predetermined distance may be a value variable based on the vehicle speed. The control circuit 130 can recognize the distance between the present vehicle position and the road inclination changing point P based on the information received from the navigation system unit 95. When an affirmative determination is made in step S60, step S80 is performed. On the other hand, when a negative determination is made in step S60, step S70 is performed.

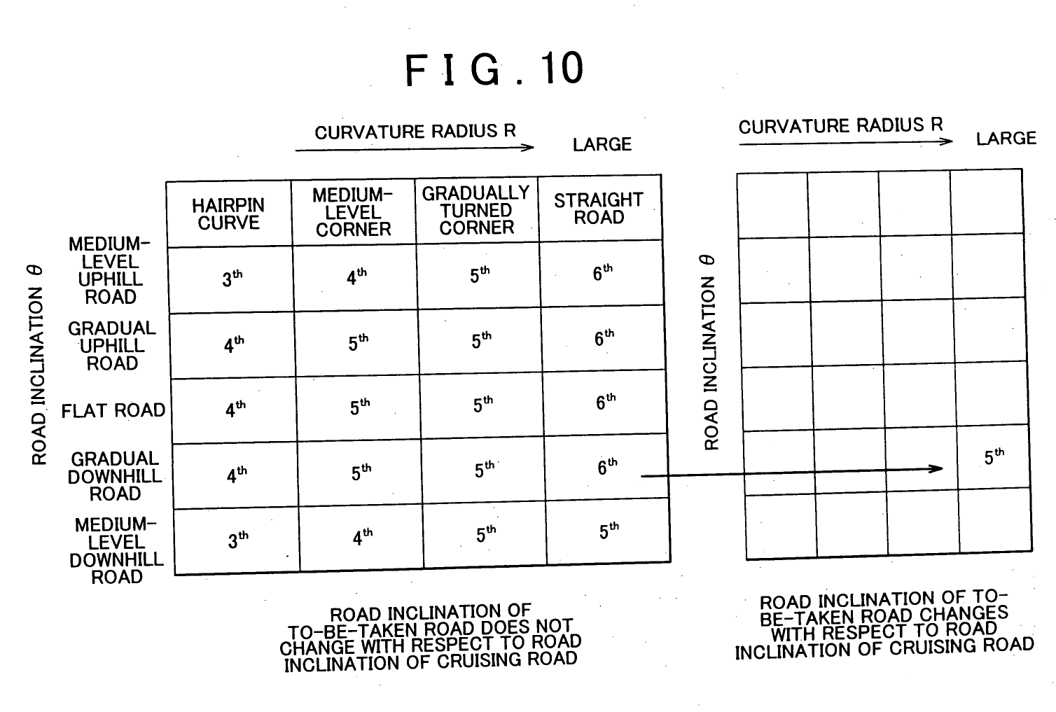

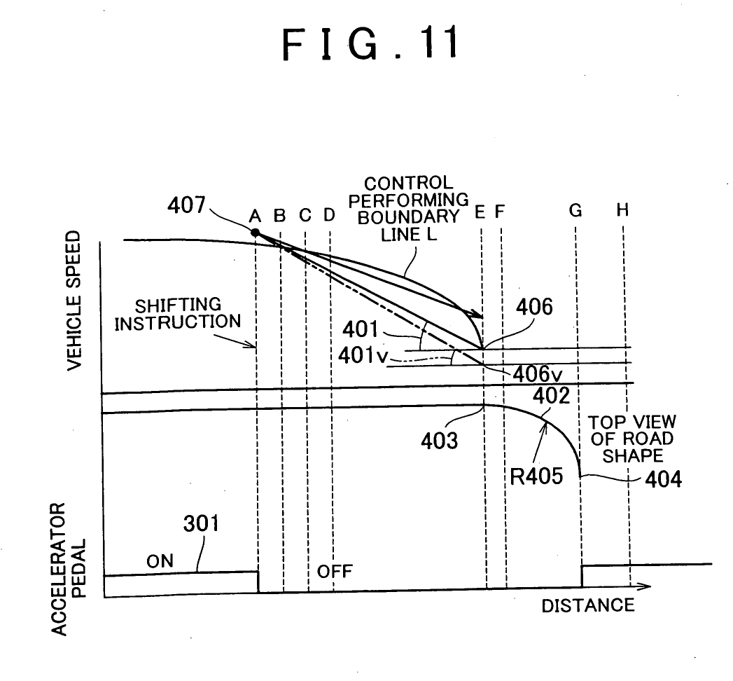

In step S70, the control circuit 130 changes the threshold value for the corner control to a value at which the downshifting of the automatic transmission 10 can be performed more easily (not shown), or changes the shift speed map to a shift speed map based on which a lower shift speed is selected (FIG. 10). Namely, the threshold value is changed from the default threshold value to the threshold value at which downshifting is performed more easily, or the shift speed map is changed from the default shift speed map based on which a lower shift speed is selected.

FIG. 10 shows maps for describing the shift speed map changed in step S70. In the shift speed map in FIG. 10, the shift speed to be selected is shown in a two-dimensional coordinate whose horizontal axis indicates the curvature radius R of the corner located ahead of the vehicle and whose vertical axis indicates the road inclination θ of the road. The left side map in FIG. 10 shows the shift speed map (default map) which is used when the shift speed map is not changed (when step S70 is not performed) (“NO” in step S50 or “YES” in step S60). Meanwhile, the right side map in FIG. 10 shows the shift speed map which is used when the shift speed map is changed in step S70 (“NO” in step S60).

As shown in FIG. 10, when the shift speed map is changed in step S70, if the road inclination of the cruising road and the curvature radius R do not change before and after the shift speed map is changed, a shift speed, which is lower than the shift speed selected based on the (default) shift speed map used before changing the shift speed map, is selected. After step S70 is completed, step S80 is performed.

When it is determined in step S60 that the distance between the present vehicle position and the road inclination changing point P is equal to or shorter than the predetermined distance (“YES” in step S60), and step S80 is then performed without performing step S70, the default threshold valve or the default shift speed map (the map on the left side in FIG. 10) are used in step S80.

In step S80, the control circuit 130 decides the shift speed (amount of downshifting) to be selected when shift control (downshifting) of the automatic transmission 10 is performed. When the shift speed to be selected is decided in step S80, the shift speed map shown in FIG. 10 or the threshold value for the corner control (not shown) is used. In FIG. 10, the shift speed to be achieved by downshifting of the corner control is set based on the curvature radius R of the corner 402 and the road inclination θ at the point A at which the accelerator pedal is fully released and the brake is also fully released (“YES” in step S10).

A description will be made on the assumption that the curvature radius R of the corner 402 is large and the corner 402 is close to a straight line, and the point A is on the gently downhill road. In this case, based on the default shift speed map on the left side in FIG. 10, sixth speed is the optimum shift speed. Meanwhile, when the conditions of the corner 402 and the point A are the same as the above-mentioned conditions, based on the shift speed map on the right side in FIG. 10 that is used when the shift speed map is changed, fifth speed is the optimum shift speed.

In step S80, the optimum shift speed decided based on the shift speed map is compared with the present shift speed, and it is determined whether the present shift speed is higher than the optimum shift speed. When it is determined that the present shift speed is higher than the optimum shift speed, it is determined that a request for downshifting of the corner control is made, and an instruction to perform shifting is output. On the other hand, when the present shift speed is not higher than the optimum shift speed, it is determined that there is no request for downshifting of the corner control, and an instruction for shifting is not output.

In the fourth embodiment, fifth speed is the optimum shift speed based on the shift speed map on the right side in FIG. 10 which is used when the shift speed map is changed in step S70. Since the present shift speed is sixth speed at the point A, it is determined in step S80 that a request for downshifting to fifth speed is made. In step S80, as described above, when the control circuit 130 decides the shift speed (fifth speed in the embodiment) to be achieved, a shifting instruction is output.

The downshifting instruction is output as soon as the control circuit 130 determines at the point (time point) indicated by the reference character “A” in FIG. 11 that downshifting needs to be performed as the shift point control according to the fourth embodiment. After step S80 is completed, step S90 is performed.

Step S90 is the same as step S80 in FIG. 1B. In step S90, the control circuit 130 determines whether the threshold vale or the shift speed map has been changed in step S70. When an affirmative determination is made, step S100 is performed. On the other hand, when a negative determination is made, the control routine is reset. In the fourth embodiment, since the threshold value or the shift speed map has been changed, step S100 is performed.

Step S100 is the same as step S90 in FIG. 1B. In step S100, the control circuit 130 determines whether the vehicle has passed the road inclination changing point P. The control circuit 130 can determine whether the vehicle has passed the road inclination changing point P based on the information received from the navigation system unit 95. When it is determined in step S100 that the vehicle has not passed the road inclination changing point P (“NO” in step S100), the flag F is set to “1” in step S200, after which the control routine is reset. Then, steps S10, S20 and the following steps are repeatedly performed until an affirmative determination is made in step S100. On the other hand, when it is determined in step S100 that the vehicle has passed the road inclination changing point P (“YES” in step S100), step S110 is performed.

In step S110, the control circuit 130 determines whether the distance between the present vehicle position and the starting point 403 of the corner 402 is equal to or longer than a predetermined value. The predetermined value is stored in the ROM 133 in advance. The control circuit 130 made a determination in step S110 based on the data indicating the present vehicle position and the position of the starting point 403 of the corner 402 received from the navigation system unit 95. When an affirmative determination is made in step S110, step S120 is performed. On the other hand, when a negative determination is made in step S110, step S130 is performed.

When it is determined in step S110 that the distance between the present vehicle position and the starting point 403 of the corner 402 is shorter than the predetermined value (“NO” in step S110), namely, when the present vehicle position is close to the starting point 403 of the corner 402 (when the vehicle is about to enter the corner 402), neither the threshold value nor the shift speed map is changed to the default value such that upshifting is not caused (step S120 is skipped), since upshifting caused immediately before the vehicle enters the corner makes the driver feel a sense of discomfort. Namely, when the present vehicle position is close to the starting point 403 of the corner 402 (when the vehicle is about to enter the corner 402) (“NO” in step S110), the vehicle enters the corner 402 (“YES” in step S130) without changing the threshold value to the default threshold value or without changing the shift speed map to the default shift speed map. Then, as described later, after the vehicle has come out of the corner 402 (“YES” in step S150), the threshold value is changed to the default threshold value, or the shift speed map is changed to the default shift speed map in step S170 after a negative determination is made in step S160.

Step 120 is the same as step S100 in FIG. 1B. In step S120, the control circuit 130 changes the threshold value to the default threshold value, or the shift speed map to the default shift speed map. After step S120 is completed, step S130 is performed.

In step S130, the control circuit 130 determines whether the vehicle has entered the corner 402. The control circuit 130 makes a determination in step S130 based on the data indicating the present vehicle position and the position of the starting point 403 of the corner 402 received from the navigation system unit 95. When an affirmative determination is made in step S130, step S140 is then performed. On the other hand, when a negative determination is made in step S130, the flag F is set to “2” in step S210, after which the control routine is reset. Then, steps S10, S20 and the following steps are repeatedly performed until an affirmative determination is made in step S130.

When the control routine is initially performed, since the vehicle has not entered the corner 402 (“NO” in step S130), the flag F is set to “2” in step S210, after which the control routine is reset. In the control routine performed again, when the accelerator pedal is fully released (“YES” in step S10), the flag F shows “2” (“2” in step S20). Therefore, step S130 is then performed, and the steps are repeatedly performed until an affirmative determination is made in step S130.

When an affirmative determination is made in step S130(“YES” in step S130), step S140 is then performed. In FIG. 11, the vehicle enters the corner 402 at the point (time point) indicated by the reference character “E”.

In step S140, the control circuit 130 restricts upshifting. While the vehicle is turning the corner 402 after entering the corner 402, restriction is placed on upshifting to a shift speed relatively higher than a shift speed achieved by downshifting in step S80. Even in the shift point control for a normal corner, upshifting is prohibited while the vehicle is turning the corner after entering the corner. Note that there is no particular restriction placed on downshifting since the driver may request an acceleration force due to, for example, kick down while the vehicle is turning the corner after entering the corner 402. After step S140 is completed, step S150 is performed.

In step S150, the control circuit 130 determines whether the vehicle has come out of the corner 402. The control circuit 130 makes a determination in step S150 based on the data indicating the present vehicle position and the position of the ending point 404 of the corner 402, which is received from the navigation system unit 95. When an affirmative determination is made in step S150, step S160 is performed. On the other hand, when a negative determination is made, step S220 is performed.

When the control routine is initially performed, since the vehicle has not come out of the corner 402 (“NO” in step S150), the flag F is set to “3” in step S220, after which the control routine is reset. In the control routine performed again, when the accelerator pedal is fully released (“YES” in step S10), the flag F shows “3” (“3” in step S20). Therefore, step S150 is performed with restriction placed on upshifting maintained, and the steps are repeatedly performed until an affirmative determination is made in step S150.

When an affirmative determination is made in step S150 (“YES” in step S150), step S160 is performed. In FIG. 11, the vehicle comes out of the corner 402 at the point (time point) indicated by the reference character “G”.

In step S160, the control circuit 130 determines whether the threshold value has been changed to the default threshold value or the shift speed map has been changed to the default shift speed map. Namely, it is determined in step S160 whether an affirmative determination is made in step S10 and then the threshold value is changed to the default threshold value or the shift speed map is changed to the default shift speed map in step S120. When it is determined in step S160 that the threshold value has not been changed to the default threshold value or the shift speed map has not been changed to the default shift speed map (“NO” in step S160), the threshold value is changed to the default threshold value or the shift speed map is changed to the default shift speed map in step S170.

As described above, when it is determined in step S10 that the position at which the vehicle has passed the road inclination changing point P is close to the point at which the vehicle enters the corner 402 (“NO” in step S110), the vehicle enters the corner 402 (“YES in step S130) without changing the threshold value to the default threshold value and without changing the shift speed map to the default shift speed map such that upshifting is not caused. After the vehicle comes out of the corner 402 (“YES” in step S150), the threshold value is changed to the default threshold value or the shift speed map is changed to the default shift speed map in step S170 after a negative determination is made in step S160. After step S170 is completed, step S1180 is performed.

In step S180, the control circuit 130 removes the restriction placed on shifting. After step S180 is completed, step S190 is performed.

In step S190, the control circuit 130 sets the flag F to “0”. After step S190 is completed, the control routine is reset.

In step S50 in FIG. 8A, the predetermined value is set to a sufficiently high value such that upshifting is not caused as soon as the threshold value is changed to the default threshold value or the shift speed map is changed to the default shift speed map in step S1120. The predetermined value is set to a high value at which downshifting is caused in the condition in which the curvature radius R is the same and only the road inclination is different, in the shift speed map of the normal corner control (default shift speed map).

According to the above-mentioned embodiments, the following effects can be obtained. In the first embodiment, the invention is applied to the downhill control. However, the invention can be applied to the corner control as described in the fourth embodiment. According to the fourth embodiment, the same effect as that of the first embodiment can be obtained.

In the first, second, and third embodiments, the deceleration control is performed based on the road inclination by using only the automatic transmission 10. In the fourth embodiment, the deceleration control is performed based on the road inclination and the curvature radius R by controlling the automatic transmission 10. The invention can be applied to the deceleration control based on the road inclination by using only the brake. In this case, the brake control can be performed by using a braking device which causes a braking force of the vehicle, for example, a regenerative brake using a MG (motor generator) device provided in a power train system instead of using the brake. Also, the invention can be applied to the deceleration control based on the road inclination and the curvature radius R, which is performed by controlling the automatic transmission 10 and the brake device in cooperation. When only the brake is used, or when the cooperative control of the automatic transmission 10 and the brake device is performed, for example, in the case in FIG. 8A, in step S70, the map or a calculation formula (a coefficient is changed) may be used based on which the target deceleration that is higher than that at the normal time (default) is set.

In step S40 in FIG. 1A and step S60 in FIG. 8A, it is determined whether the distance between the present vehicle position and the road inclination changing point P is equal to or shorter than the predetermined distance. Only when it is determined that the distance between the present vehicle position and the road inclination changing point P is longer than the predetermined distance, the threshold value or the shift speed map is changed. In this case, only when the distance between the present vehicle position and the road inclination changing point P is longer than the predetermined distance and equal to or shorter than the preset distance, the threshold value or the shift speed may be changed. In this case, the preset distance is longer than the predetermined distance (preset distance>predetermined distance). When the distance between the present vehicle position and the road inclination changing point P is considerably long, the driver does not feel anxious. Only when the distance between the present vehicle position and the road inclination changing point P is equal to or shorter than the preset distance, the threshold value or the shift speed map needs to be changed.

In the above-mentioned embodiments, the description is made concerning the case in which the stepped automatic transmission 10 is used as the transmission. However, the invention can be applied to a continuously variable transmission (CVT). In addition, in the above-mentioned embodiments, the deceleration (G) is used as the deceleration indicating the amount of speed reduction achieved by the vehicle. However, the control may be performed based on the deceleration torque. Further, it should be noted that in the above-mentioned embodiments, the to-be-taken road and the cruising road are not limited to being two stretches of a same road and neither are they limited to being two stretches of distinct but connected roads.

While the invention has been described with reference to exemplary embodiments thereof, it is to be understood that the invention is not limited to the exemplary embodiments or constructions. On the contrary, the invention is intended to cover various modifications and equivalent arrangements. In addition, while the various elements of the exemplary embodiments are shown in various combinations and configurations, all of which are exemplary, other combinations and configurations, including additional or fewer elements, or even a single element, are also within the spirit and scope of the invention.

What is claimed is:

1. A deceleration control apparatus for controlling a deceleration of a vehicle based on at least a road inclination, comprising:
a controller configured to change at least one of a deceleration applied to the vehicle and a threshold used in performing the deceleration control based on a change of a road inclination of a to-be-taken road located ahead of a cruising road on which the vehicle is presently running or will run soon with respect to a road inclination of the cruising road, wherein:
the change of the road inclination of the to-be-taken road corresponds to a downhill inclination with respect to the cruising road.

2. The deceleration control apparatus according to claim 1, wherein:
the controller is configured to change at least one of the deceleration applied to the vehicle and the threshold used in performing the deceleration control when a distance between a present vehicle position and a point at which the change of the road inclination of the to-be-taken road with respect to the road inclination of the cruising road occurs is longer than a predetermined distance.

3. The deceleration control apparatus according to claim 2, wherein:
the controller sets the predetermined distance based on a speed of the vehicle.

4. The deceleration control apparatus according to claim 3, wherein:
the controller sets the predetermined distance to be longer as the speed of the vehicle increases.

5. The deceleration control apparatus according to claim 1, wherein:
the controller is configured to restrict upshifting after the vehicle has passed a point at which the change of the road inclination of the to-be-taken road with respect to the road inclination of the cruising road occurs.

6. The deceleration control apparatus according to claim 1, wherein:
the controller is configured to change both the deceleration applied to the vehicle and the threshold used in performing the deceleration control.

7. The deceleration control apparatus according to claim 6, wherein:
the controller is configured to change both the deceleration applied to the vehicle and the threshold used in performing the deceleration control when a distance between a present vehicle position and a point at which the change of the road inclination of the to-be-taken road with respect to the road inclination of the cruising road occurs is longer than a predetermined distance.

8. The deceleration control apparatus according to claim 7, wherein:
the controller sets the predetermined distance based on a speed of the vehicle.

9. The deceleration control apparatus according to claim 8, wherein:
the controller sets the predetermined distance to be longer as the speed of the vehicle increases.

10. The deceleration control apparatus according to claim 6, wherein:
the controller is configured to restrict upshifting after the vehicle has passed a point at which the change of the road inclination of the to-be-taken road with respect to the road inclination of the cruising road occurs.

11. A deceleration control method for controlling a deceleration of a vehicle based on at least a road inclination, comprising the steps of:
detecting a change of a road inclination of a to-be-taken road located ahead of a cruising road on which the vehicle is presently running or will run soon with respect to a road inclination of the cruising road; and
changing at least one of deceleration applied to the vehicle and a threshold used in performing the deceleration control based on the change of the road inclination of the to-be-taken road, wherein:
the change of the road inclination of the to-be-taken road corresponds to a downhill inclination with respect to the cruising road.

12. The deceleration control method according to claim 11, wherein:
at least one of the deceleration applied to the vehicle and the threshold used in performing the deceleration control is changed when a distance between a present vehicle position and a point at which the change of the road inclination of the to-be-taken road with respect to the road inclination of the cruising road occurs is longer than a predetermined distance.

13. The deceleration control method according to claim 12, wherein:
the predetermined distance is set based on a speed of the vehicle.

14. The deceleration control method according to claim 13, wherein:
the predetermined distance is set to be longer as the speed of the vehicle increases.

15. The deceleration control method according to claim 11, further comprising the step of:
restricting upshifting after the vehicle has passed the point at which the change of the road inclination of the to-be-taken road with respect to the road inclination of the cruising road occurs.

16. The deceleration control method according to claim 12, further comprising the step of:
restricting upshifting after the vehicle has passed the point at which the change of the road inclination of the to-be-taken road with respect to the road inclination of the cruising road occurs.

17. The deceleration control method according to claim 13, further comprising the step of:
restricting upshifting after the vehicle has passed the point at which the change of the road inclination of the to-be-taken road with respect to the road inclination of the cruising road occurs.

18. The deceleration control method according to claim 14, further comprising the step of:
restricting upshifting after the vehicle has passed the point at which the change of the road inclination of the to-be-taken road with respect to the road inclination of the cruising road occurs.

19. The deceleration control method according to claim 11, wherein the changing step comprises:
changing both the deceleration applied to the vehicle and the threshold used in performing the deceleration control.

20. The deceleration control method according to claim 19, further comprising the step of:
restricting upshifting after the vehicle has passed the point at which the change of the road inclination of the to-be-taken road with respect to the road inclination of the cruising road occurs, wherein:
the deceleration applied to the vehicle and the threshold used in performing the deceleration control are changed when a distance between a present vehicle position and a point at which the change of the road inclination of the to-be-taken road with respect to the road inclination of the cruising road occurs is longer than a predetermined distance.
